(19) United States
(12) Patent Application Publication
(10) Pub. No.: US 2006/0005258 A1
(43) Pub. Date: Jan. 5, 2006

(54) Contents distribution system, method thereof, server, user terminal, encryption device, managing device and streaming device

(75) Inventor: Takeshi Hirose, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/030,105

(22) Filed: Jan. 7, 2005

(30) Foreign Application Priority Data
Jul. 1, 2004 (JP) 002486/2004

(51) Int. Cl. G06F 17/30

(52) U.S. Cl. 726/27

(57) ABSTRACT

A contents distribution system and a method thereof, a server, a user terminal, an encryption device, a managing device, and a streaming device for enabling contents to be acquired inexpensively by performing charging in accordance with viewing time only, and also a communication charge to be limited only to a charge for acquiring encryption key information. A contents management server transmits contents information encrypted by an encryption processing section of a contents encryption device to a user terminal via a communication network, and a streaming server device transmits an encryption key information made into a stream via a portable telephone communication network so as to enable a charging processing section to calculate a charge based on the state of the transmission.

### BACKGROUND OF THE PRESENT INVENTION

1. Field of the Present Invention

The present invention relates to a contents distribution system, a method thereof, a server, a user terminal, an encryption device, a managing device, and a streaming device, for enabling the minimization of the effect of communication charge and communication time at the time of distributing large-capacity contents, and charging in accordance with viewing time of the contents.

2. Description of the Related Art

In recent years, with development, etc. of the Internet technology and a moving picture compression technology, services for distributing and selling large-capacity contents such as moving picture data to a user terminal via the Internet have been provided. Generally, in such services, digital contents, such as moving picture data, are in many cases stored in a server on the Internet, so as to be distributed in response to a request from a user terminal.

However, when large-capacity contents, such as a moving picture data are distributed and sold by means of a portable radio terminal which is a portable communication apparatus, such as a portable telephone or PDA (Personal Digital Assistant), a user must bear a greater burden of communication charge and communication time by using a mobile network such as a portable telephone communication network than a charge for the contents, as a result of which such services are made impractical.

In order to cope with the problem, there has been proposed a method for individually distributing encrypted contents data and encryption keys of the encrypted contents in Japanese Patent Application laid open No. 2003-229843.

Also, in Japanese Patent Application laid open No. 2003-6734, there has been proposed a technique, wherein an automatic vending machine comprises means for receiving encrypted contents data from a server, while a portable terminal comprises means for receiving the encrypted contents data from the automatic vending machine and means for receiving key data for decrypting from the server, and the server comprises means for performing charging at the time of transmitting the key data to the portable terminal, and thereby, in the case of downloading large-capacity digital contents, charge collection is performed while reducing a load imposed on a user.

### SUMMARY OF THE PRESENT INVENTION

However, the above described prior art has the following problems.

For individually distributing encrypted contents data and encryption key for the encrypted contents, the contents and encryption key need to be individually downloaded using independent procedures, which makes user's procedure complicated. In addition, there is a problem in which the contents themselves are not made into streams, thereby making charging in accordance with viewing time difficult, whereas traffic is extremely reduced in the case where fixed encryption keys are distributed and sold in order to avoid a high increase in the use's communication charge due to the increase of traffic caused by performing stream distribution of contents themselves, as a result of which a business interest on the side of communications carriers cannot be aroused.

It is therefore an object of the present invention to provide a contents distribution system, a method thereof, a server, a user terminal, an encryption device, a managing device, and a streaming device, for enabling large capacity contents, such as a moving picture, to be acquired and viewed inexpensively based on charging in accordance with viewing time only, and also a communication charge to be limited to a charge for acquiring an encryption key, thereby substantially reducing the communication charge.

In accordance with the first aspect of the present invention, there is provided a contents distribution system including a server and a user terminal which are connected via a network, wherein the server comprises: an acquisition section for acquiring contents information; an encryption section for encrypting contents information acquired by the acquisition section; an encrypted contents storage for storing contents information encrypted by the encryption section; and an encryption key storage for making encryption key information used for encrypting by the encryption section into a stream and storing the encryption key information, the user terminal comprises: a first communication section for receiving the encrypted contents information from the server via a first network; a second communication section for receiving the encryption key information made into a stream from the server via a second network having a speed lower than the first network; and a decryption section for decrypting the encrypted contents information received by the first communication section using the encryption key information received by the second communication section.

In accordance with the second aspect of the present invention, in the contents distribution system of the first aspect, the server further comprises a transmission measuring section for measuring the state of transmission of the encryption key information so as to enable the user terminal to receive the encryption key information by the second communication section.

In accordance with the third aspect of the present invention, in the contents distribution system of the second aspect, the transmission measuring section measures transmission time and/or the number of transmissions of the encryption key information to the user terminal.

In accordance with the fourth aspect of the present invention, in the contents distribution system of any one of the first to third aspects, the server further comprises a charging processing section for calculating use charge based on the encrypted contents information and/or the encryption key information, each information being received by the user terminal via the network.

In accordance with the fifth aspect of the present invention, in the contents distribution system of any one of the first to fourth aspects, the user terminal further comprises a display for displaying the encrypted contents information decrypted by the decryption section.

In accordance with the sixth aspect of the present invention, in the contents distribution system of any one of the first to fifth aspects, the server further comprises: a generation section for generating partial contents information which is contents information acquired by the acquisition section and which is not encrypted by the encryption section; and a partial contents information disclosing section for enabling the non-encrypted partial contents information generated by the generation section to be disclosed and viewed by the user terminal.

In accordance with the seventh aspect of the present invention, in the contents distribution system of any one of the first to sixth aspects, the server further comprises an encryption key location information disclosing section for enabling information on location where the encryption key information is stored by the encryption key storage to be disclosed and viewed by the user terminal.

In accordance with the eighth aspect of the present invention, there is provided a server comprising: an acquisition section for acquiring contents information; an encryption section for encrypting contents information acquired by the acquisition section; an encrypted contents storage for storing contents information encrypted by the encryption section; an encryption key storage for making encryption key information used for encrypting by the encryption section into a stream and storing the encryption key information; and a communication section for transmitting the encrypted contents information via a first network, and transmitting the encryption key information made into a stream via a second network having a speed lower than the first network.

In accordance with the ninth aspect of the present invention, the server of the eighth aspect further comprises a transmission measuring section for measuring the state of transmission of the encryption key information by the communication section.

In accordance with the tenth aspect of the present invention, in the server of the ninth aspect, the transmission measuring section measures transmission time and/or the number of transmissions of the encryption key information.

In accordance with the eleventh aspect of the present invention, the server of any one of the eighth to tenth aspects further comprises a charging processing section for calculating use charge based on the encrypted contents information and/or encryption key information, each information being transmitted via the network.

In accordance with the twelfth aspect of the present invention, there is provided a user terminal comprising: a first communication section for receiving encrypted contents information via a first network; a second communication section for receiving encryption key information made into a stream via a second network with a speed lower than the first network; and a decryption section for decrypting the encrypted contents information received by the first communication section using the encryption key information received by the second communication section.

In accordance with the thirteenth aspect of the present invention, the user terminal of the twelfth aspect further comprises a display for displaying the encrypted contents information decrypted by the decryption section.

In accordance with the fourteenth aspect of the present invention, there is provided a contents encryption device comprising: an acquisition section for acquiring contents information; an encryption section for encrypting contents information acquired by the acquisition section; and a streaming section for making encryption key information used for encrypting the contents information into a stream.

In accordance with the fifteenth aspect of the present invention, there is provided a contents managing device comprising: an encrypted contents acquisition section for acquiring encrypted contents information; an encrypted contents storage for storing the encrypted contents information acquired by the encrypted contents acquisition section; and a communication section for transmitting the encrypted contents information via a network.

In accordance with the sixteenth aspect of the present invention, there is provided a streaming device comprising: an encryption key information acquisition section for acquiring encryption key information which is made into a stream and used for encrypting contents information; an encryption key storage for storing the encryption key information; and a communication section for transmitting the encryption key information made into a stream via a network.

In accordance with the seventeenth aspect of the present invention, the streaming device of the sixteenth aspect further comprises a transmission measuring section for measuring the state of transmission of the encryption key information by the communication section.

In accordance with the eighteenth aspect of the present invention, in the streaming device of the seventeenth aspect, the transmission measuring section measures transmission time and/or the number of transmissions of the encryption key information.

In accordance with the nineteenth aspect of the present invention, the streaming device of any one of the sixteenth to eighteenth aspects further comprises a charging processing section for calculating use charge based on the encrypted contents information and/or the encryption key information, each information being transmitted via the network.

In accordance with the twentieth aspect of the present invention, there is provided a contents distribution method utilizing a server and a user terminal which are connected via a network, wherein the server comprises the steps of: acquiring contents information by an acquisition section; encrypting by an encryption section contents information acquired by the acquisition section; storing by an encrypted contents storage the contents information encrypted by the encryption section; and making an encryption key storage convert encryption key information used for encrypting by the encryption section into a stream to store the encryption key information, and the user terminal comprises the steps of: receiving the encrypted contents information from the server by a first communication section via the first network; receiving the encryption key information made into a stream from the server by a second communication section via the second network with a speed lower than the first network; and decrypting by a decryption section the encrypted contents information received by the first communication section using the encryption key information received by the second communication section.

In accordance with the twenty-first aspect of the present invention, in the contents distribution method of the twentieth aspect, the server further comprises the step of measuring the state of transmission of the encryption information by a transmission measuring section so as to enable the user terminal to receive the encryption key information by the second communication section.

In accordance with the twenty-second aspect of the present invention, in the contents distribution method of the twenty-first aspect, in the measuring step, the transmission measuring section measures transmission time and/or the number of transmissions of the encryption key information to the user terminal.

In accordance with the twenty-third aspect of the present invention, in the contents distribution method of any one of the twentieth to twenty-second aspects, the server further comprises the step of calculating use charge by a charging processing section based on the encrypted contents information and/or the encryption key information, each information being received by the user terminal via the network.

In accordance with the twenty-fourth aspect of the present invention, in the contents distribution method of any one of the twentieth to twenty-third aspects, the user terminal further comprises the step of displaying by a display the encrypted contents information decrypted by the decryption section.

In accordance with the twenty-fifth aspect of the present invention, in the contents distribution method of any one of the twentieth to twenty-fourth aspects, the server further comprises the steps of: generating by a generation section partial contents information which is acquired by the acquisition section and which is not encrypted by the encryption section; and enabling the non-encrypted partial contents information generated by the generation section to be disclosed by a partial contents information disclosing section, and to be viewed by the user terminal.

In accordance with the twenty-sixth aspect of the present invention, in the contents distribution method of any one of the twentieth to twenty-fifth aspects, the server further comprises the step of enabling information of location where the encryption key information is stored by the encryption key storage to be disclosed by an encryption key location information disclosing section, and to be viewed by the user terminal.

### BRIEF DESCRIPTION OF THE DRAWINGS

FIG. 1 is a diagram showing a system concept of an embodiment according to the present invention;

FIG. 2 a diagram showing a system construction in an embodiment according to the present invention;

FIG. 3 is a flowchart showing operation for encrypting and disclosing contents information in an embodiment according to the present invention;

FIG. 4 is a flowchart showing operation for acquiring encrypted contents information in an embodiment according to the present invention; and

FIG. 5 is a flowchart showing operation for charging by streaming of encryption key information in an embodiment according to the present invention.

### DESCRIPTION OF THE PREFERRED EMBODIMENT

Referring now to the drawings, a description will be given of a preferred embodiment of the present invention.

Charging which is performed only in accordance with viewing time so as to enable a user to acquire and view inexpensively large-capacity contents such as a moving picture, and communication charge which is limited to a charge for acquiring encryption key information so as to be substantially reduced, can be realized by providing, a contents encryption device comprising: an acquisition section for acquiring contents information; an encryption section for encrypting the contents information acquired by the acquisition section; and a transmission section for transmitting the contents information encrypted by the encryption section, a contents managing device comprising: an encrypted contents acquisition section for acquiring the encrypted contents information; an encrypted contents storage for storing the encrypted contents information acquired by the encrypted contents acquisition section; and a communication section for transmitting the encrypted contents information via a network, a streaming device comprising: an encryption key information acquisition section for acquiring encryption key information used for encrypting the contents information; an encryption key storage for making the encryption key information into a stream and storing the encryption key information; a communication section for transmitting the encryption key information made into a stream via the network; a transmission measuring section for measuring the state of transmission of the encryption key information by the communication section; and a charging processing section for calculating use charge based on the encrypted contents information and/or the encryption key information, each information being transmitted via the network.

In the following, the configuration and operation according to an embodiment of the present invention will be explained with reference to the accompanying drawings.

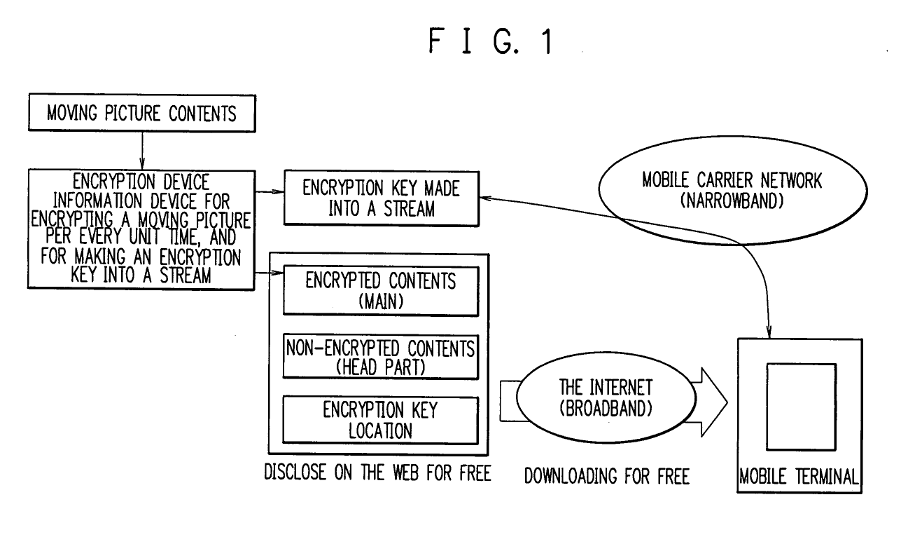

FIG. 1 is a diagram showing a concept of an embodiment according to the present invention. Referring to FIG. 1, moving picture contents are encrypted by an encryption device and encrypted contents, non-encrypted contents and encryption keys are disclosed on the homepage for free. A mobile terminal acquires the information disclosed for free via the Internet and the encryption key made into a stream via a mobile carrier network, so as to decrypt and view moving picture contents.

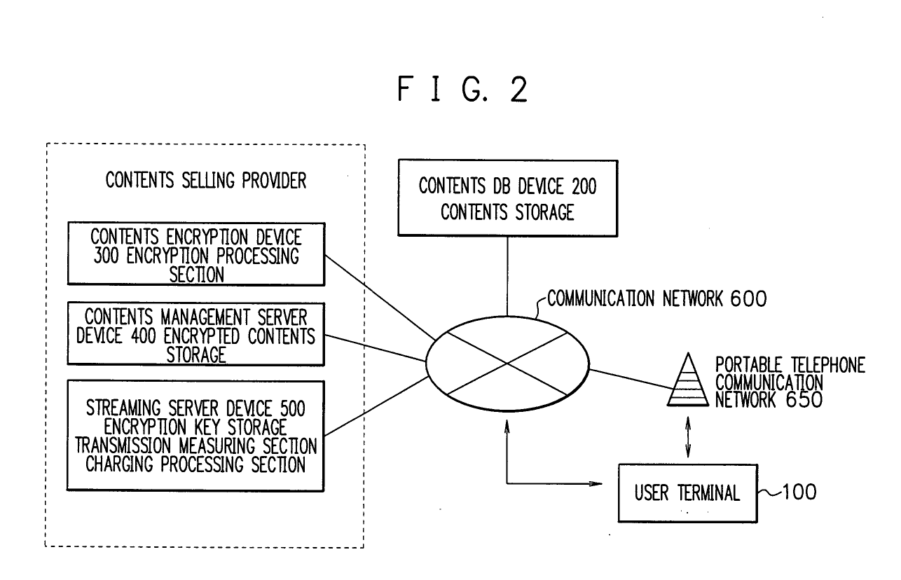

FIG. 2 is a diagram showing the configuration of a contents distribution system according to the embodiment. Referring to FIG. 2, the contents distribution system comprises a user terminal 100 which is a portable radio terminal, a contents DB device 200 which is operated by a content right holder or an enterprise entrusted by the content right holder, a contents encryption device 300 which performs encryption processing etc. of contents information at the side of an enterprise selling the contents, a contents management server device 400 which transmits encrypted contents information, etc. in response to a request from the user terminal 100, a streaming server device 500 which stores an encryption key, and a portable telephone communication network 650, each being connected via a communication network 600. In addition, the streaming server device 500 and the user terminal 100 are connected via the portable telephone communication network 650.

The user terminal 100 is a portable radio terminal which has a large-capacity data communication function with a speed higher than that of the portable telephone communication network 650. Here, the large-capacity data communication function is, for example, a wireless LAN etc. The portable radio terminal is also, for example, a portable telephone, PHS (Personal Handy Phone), a notebook-sized personal computer, a Personal Digital Assistant, or the like.

The user terminal 100 comprises a radio communication section which is a first communication section having a function of transmitting/receiving radio signals to/from a portable telephone base station, etc. included in the portable telephone communication network 650 connected to a portable phone etc., and a wireless LAN communication section which is a second communication section having a function of transmitting/receiving radio signals to/from a wireless LAN relaying apparatus (not shown). In this embodiment, the second communication section, which performs wireless LAN communication, may be other communication systems, such as Bluetooth or infrared communication system.

The user terminal 100 may further comprise: a GPS positioning section having a function of receiving a signal from a GPS Satellite to perform positioning of its own position; a camera section having a function of photographing a picture; an operation section comprising a ten key, a scroll key and a decision key, etc., to have a function of performing information input operation; a microphone and reception speaker which have a function of performing input/output operation corresponding to a transmission reception section having a function of performing voice signal processing; a notification speaker having a function of outputting a notice sound, etc.; a display having a function of displaying various kinds of information; a storage having a function of storing various settings relating to telephone book information, transmitting/receiving mail information, incoming/outgoing call information, portable radio terminal; and a control section having a function of performing control of each part of the portable radio terminal, and a function of performing control of telephone function, Internet connecting function, wireless LAN connecting function, mail function, GPS function, and camera function and the like. The user terminal 100, in which software for reproduction is installed, may also have a function of reproducing a moving picture of a predetermined format.

The contents DB device 200, which is an information processing device for managing a data base storing original contents information which is allowed to be distributed by a content right holder, is, for example, a workstation, etc. operated by a content right holder or an enterprise to which the contents management is entrusted by the content right holder. Moving pictures such as video, the other alphabetic characters, or still images, etc. are included in the original contents.

The contents encryption device 300, which is an information processing device provided on the side of a contents selling provider, has a function of performing processing for inserting into digital contents of, for example, a picture and voice, etc., particular information such as the name of maker and seller, as an electronic watermark, in a form which does not affect the quality of contents, in order to prevent illegal copying and interpolation of data from being performed on the original contents information acquired from the contents DB device 200. In addition, the contents encryption device 300 performs encryption processing of the original contents information, and also has a function of generating partial contents information which is not encrypted. The non-encrypted partial contents information is, for example, moving picture information of a head part of contents or edited digest moving picture information, etc.

The contents management server device 400, which is an information processing device provided on the side of a contents selling provider, has a function of acquiring and storing the original contents information encrypted by the contents encryption device 300 and the non-encrypted partial contents information, and of transmitting such information to the user terminal 100 in response to a request from the user terminal 100.

The streaming server device 500, which is an information processing device provided on the side of a contents selling provider, has a function of storing a key for decrypting the original contents information encrypted by the contents encryption device 300.

The network 600, which may be an arbitrary network, for example, the Internet or a LAN (Local Area Network), etc., may only have a function of transmitting/receiving data, and may be a wired or wireless network. In the case of a wired network, for example, a LAN cable, etc. may be used, while in the case of a wireless network, infrared communication, etc. may be used.

The portable telephone communication networks 650 is an arbitrary network which can be connected to the user terminal 100 which is a portable radio terminal, and has communication function of, for example, voice communication, the Internet communication and the like.

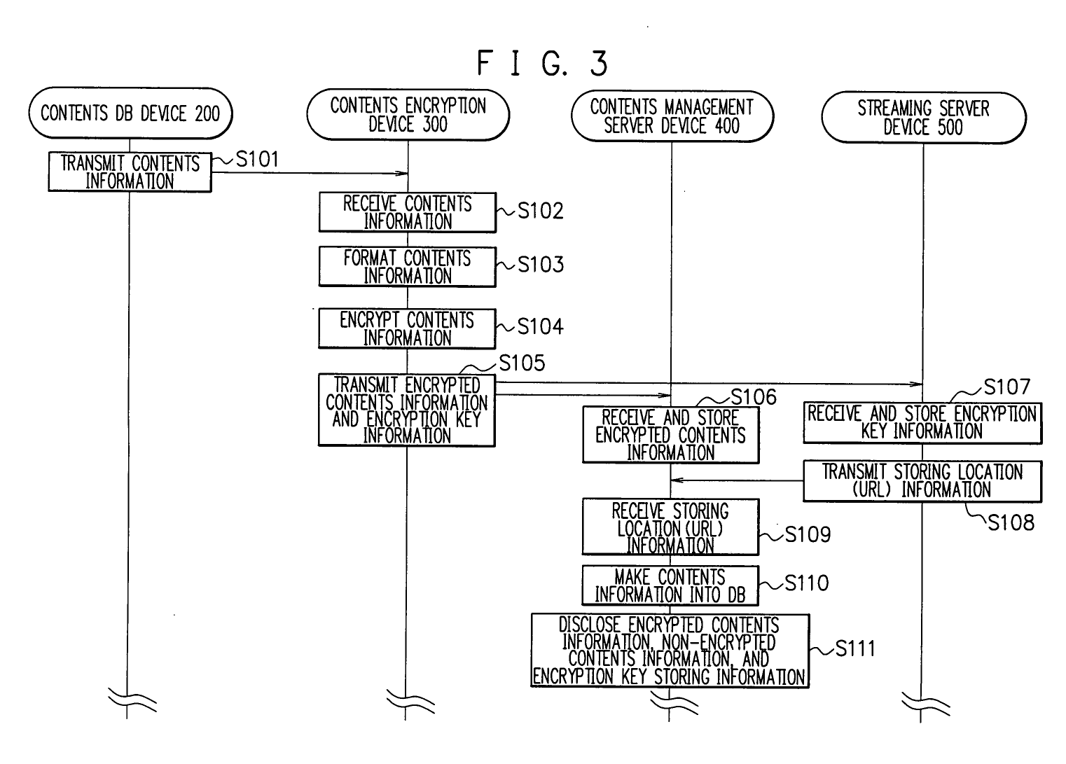

The operation of the contents distribution system in the embodiment constructed as described above will be explained with reference to FIGS. 3 to 5.

FIG. 3 shows processing procedure of distributed moving picture contents, in which a part of the contents such as a head part or a demonstration part, is stored without being encrypted, the original contents subsequent to the head part or the whole original contents are encrypted per a frame, an encrypted key of the contents is made into a stream per a unit of time, and URL (Uniform Resource Locators) which stores the encryption key is specified, and the non-encrypted partial contents and the encrypted original contents and the URL are disclosed on a website for free.

First, the contents DB device 200 on the side of a content right holder acquires contents information from a contents storage, and transmits the contents information which is permitted to be sold, to the contents encryption device 300 provided on the side of a contents selling provider via the communication network 600 (step S101).

The contents encryption device 300 receives the contents information transmitted via the communication network 600 from the contents DB device 200 (step S102), and an encryption processing section of the contents encryption device 300 converts the acquired contents information into a predetermined format, for example, MPEG format, etc., while performing processing for preventing illegal copying and interpolation of data (step S103). The processing may be, for example, inserting of an electronic watermark information, etc.

The contents information converted into the predetermined format in step S103 is encrypted by the encryption processing section of the contents encryption device 300 using an encryption key information for encryption, while being made to be partial contents information which is not encrypted (step S104). Encryption of contents information may be performed at every predetermined number of frames of a moving picture. The non-encrypted partial contents information may be, for example, a head part of the contents or information of a digest portion which is extracted from the entire part of the contents and edited.

The contents encryption device 300 transmits the encrypted contents information and the partial contents information thus generated to the contents management server device 400 via the communication network 600, while transmitting the encryption key information to the streaming server device 500 via the communication network 600 (step S105).

The contents management server device 400 receives the encrypted contents information and the partial contents information thus generated from the contents encryption device 300 via the communication network 600, and stores the information in an encrypted contents storage (step S106).

The streaming server device 500 receives via the communication network 600 the encryption key information generated by the contents encryption device 300 and stores the encryption key information in an encryption key storage (step S107).

The streaming server device 500 which stores the encryption key information in the encryption key storage in step S107 transmits URL information indicating the location where the encryption key information is stored, to the contents management server device 400 via the communication network 600 (step S108).

The contents management server device 400 receives the URL information from the streaming server device 500 via the communication network 600 (step S109).

The contents management server device 400 makes the encrypted contents information, the partial contents information, and the URL information associate to each other and converts them into a database to store the database (step S110).

The contents management server device 400 discloses in a predetermined web area each information made into the database in step S110 (step S111). This enables each of above-mentioned information to be viewed by using WWW browser, etc. from the user terminal.

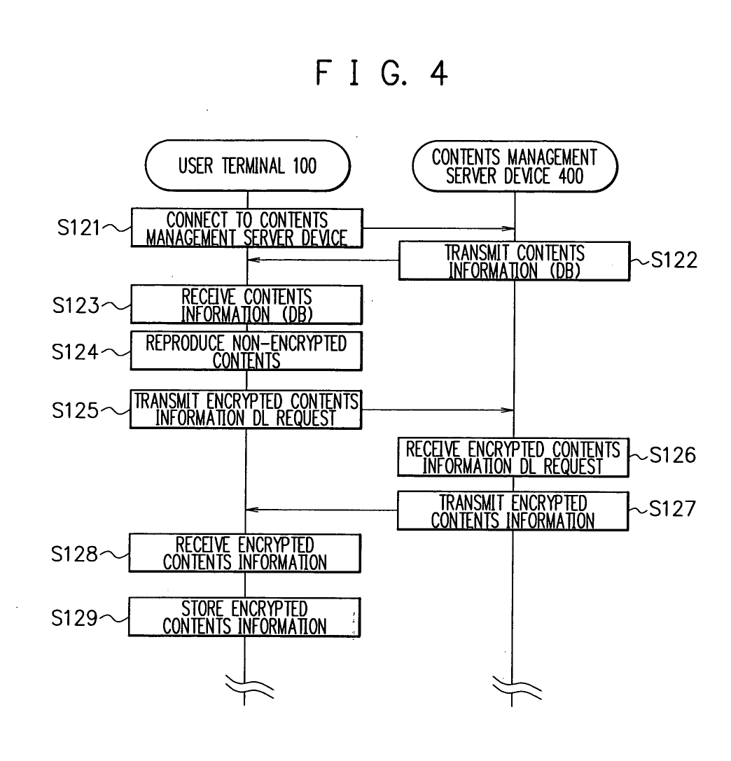

FIG. 4 is a diagram showing processing procedure in which a user acquires encrypted contents in conjunction with a distributed moving picture contents.

First, the user terminal 100 is connected through the wireless LAN communication section, which is the second communication section, to the contents management server device 400 via the communication network 600 (step S121). The contents management server device 400 may require a predetermined authentication information, for example, ID information or password information, etc., as an access permission condition, to be inputted from the operation section of the user terminal 100.

The contents management server device 400 retrieves and extracts the encrypted contents information, the partial contents information, and the URL information, which are associated to one another to be made into the database in step S110 in FIG. 3 and relates to the contents information required by the user terminal 100, and transmits the extracted contents information to the wireless LAN communication section which is the second communication section of the user terminal 100 via the communication network 600 (step S122).

The wireless LAN communication section which is the second communication section of the user terminal 100 receives the encrypted contents information, the partial contents information and the URL information, which are extracted from the contents management server device 400 and associated to one another to be made into the database, and the received information is displayed by the display of the user terminal 100 so as to be viewed by the user (step S123).

The wireless LAN communication section which is the second communication section of the user terminal 100 may receive the non-encrypted partial contents information which is searched and extracted from the encrypted contents storage of the contents management server device 400 by downloading it from the contents management server device 400 via the communication network 600, so as to reproduce the non-encrypted partial contents information as a picture on a display etc. (step S124). This enables a user to obtain reference information for determining whether to purchase the contents which the user wishes to view.

The wireless LAN communication section which is the second communication section of the user terminal 100 requires, by an input from the operation section, the contents management server device 400 to transmit the information of contents which the user wishes to view via the communication network 600 (step S125).

The contents management server 400 receives the information of contents which the user wishes to view from the user terminal 100 via the communication network 600 (step S126).

The contents management server device 400 retrieves and extracts the information of contents required by the user terminal 100 from the encrypted contents storage of the contents management server device 400, so as to transmit the extracted contents information to the wireless LAN communication section which is the second communication section of the user terminal 100 (step S127).

The wireless LAN communication section which is the second communication section of the user terminal 100 receives the contents information extracted from the contents management server device 400 (step S128), so as to store the received contents information in a predetermined storage (step S129).

The encrypted contents information may not be directly downloaded from the contents management server device 400 by the wireless LAN communication section which is the second communication section of the user terminal 100, but may be arranged to be downloaded by an information processing device, such as a personal computer, etc. (not shown) connected to a high-speed large-capacity line, so as to be acquired via a storage medium, such as a memory card.

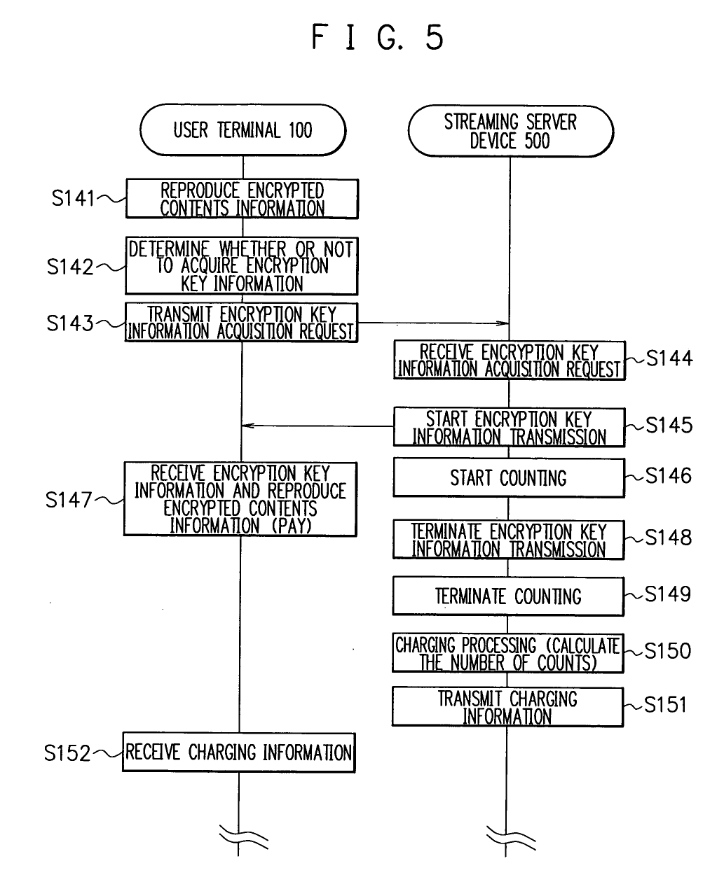

FIG. 5 is a diagram showing processing procedure in which a contents selling provider performs charging by streaming of the encryption key information.

In the user terminal 100, when reproduction of the non-encrypted partial contents information, such as a head part of contents, is ended, or when the downloaded encrypted contents information is reproduced (step S141), the display of the user terminal 100 displays a screen for selecting whether to acquire the encryption key information inserted beforehand in the partial contents information or a part of the encrypted contents information. That is, a user is notified that the subsequent viewing will be a pay service based on time charging (step S142).

In the case where a user wishes to acquire the encryption key information in order to view the contents information, the encrypted contents information, the partial contents information, and the URL information, which are received and associated to one another so as to be made into the database in step S123, are referred to by input operation from the operation section of the user terminal 100, and the URL information associated with the encrypted contents information desired to be viewed is specified, and an acquisition request for the encryption key information is transmitted via the portable telephone communication network 650 to the streaming server device 500 from the radio communication section which is the first communication section (step S143).

The streaming server device 500 receives the acquisition request for the encryption key information via the portable telephone communication network 650 from the radio communication section which is the first communication section of the user terminal 100 (step S144).

The streaming server device 500 which has received the acquisition request for the encryption key information, after acquiring and confirming ID information of the user terminal 100 which is a charging destination, extracts the required encryption key information from the encryption key storage, and transmits the encryption key information to the radio communication section which is the first communication section of the user terminal 100 via the portable telephone communication network 650 (step S145). At the same time, the transmission measuring section starts counting transmission time and the number of transmissions of the encryption key (step S146).

The user terminal 100 decrypts the encrypted contents information at every frame using the encryption key information downloaded via the portable telephone communication network 650 by the radio communication section which is the first communication section, so as to reproduce the contents information (step S147).

When the user terminal 100 discontinues or ends the reproduction of a moving picture based on the contents information, the streaming server device 500 discontinues transmission of the encryption key information to the radio communication section which is the first communication section via the portable telephone communication network 650 (step S148), and simultaneously stops counting transmission time or the number of transmissions of the encryption key performed by the transmission measuring section of the streaming server device 500 (step S149).

The streaming server device 500 then makes the charging processing section calculate the charge to be imposed on the reception of the contents information and to be paid by the user based on the number of counts performed by the transmission measuring section. The charging processing may be a method of charging in proportion to the transmission time, or a method of charging in proportion to the number of transmissions (step S150).

Finally, the streaming server device 500 transmits the charge information calculated in the charging processing section via the communication network 600 to the wireless LAN communication section which is the second communication section of the user terminal 100 (step S151), and the user terminal 100 receives the charge information, and displays the charge information on a display etc. (step S152).

Additionally, machine readable recording media, such as a magnetic disk or semiconductor memory, in which a program for performing contents distribution is recorded, are incorporated in the user terminal 100, the contents DB device 200, the contents encryption device 300, the contents management server device 400, the streaming server devices 500 or other information processing devices so as to be used, and thereby the program for performing contents distribution can be read into the information processing devices from the above mentioned recording media so as to control the operation of the information processing devices, as a result of which the processing operation shown in FIGS. 3 to 5 in the above mentioned embodiment can be realized.

Incidentally, for example, the above described first and second communication sections of the user terminal 100 may be a form using the same interface of the user terminal 100, and the first and second communication sections of the user terminal 100 may be a form utilizing the same network provided with a plurality of stages of information transfer capabilities.

As set forth hereinabove, in accordance with the present invention, charging performed only based on viewing time enables a user to acquire and view inexpensively large-capacity contents, such as a moving picture. Communication charge is also limited to a charge for acquiring encryption key information so as to be substantially reduced. Besides, in contrast to distribution and sales of fixed encryption keys in which traffic is extremely reduced, charging can be performed in accordance with viewing time of a user, which enables a business interest on the side of communication carrier to be aroused.

Further, the present invention may also be applied to an information distribution system utilizing a multimedia information terminal.

While the present invention has been described with reference to the particular illustrative embodiment, it is not to be restricted by the embodiment but only by the appended claims. It is to be appreciated that those skilled in the art can change or modify the embodiment without departing from the scope and spirit of the present invention.

What is claimed is:

1. A contents distribution system including a server and a user terminal which are connected via a network, wherein:
the server comprises:
an acquisition section for acquiring contents information;
an encryption section for encrypting contents information acquired by the acquisition section;
an encrypted contents storage for storing contents information encrypted by the encryption section; and
an encryption key storage for making encryption key information used for encrypting by the encryption section into a stream and storing the encryption key information, and
the user terminal comprises:
a first communication section for receiving the encrypted contents information from the server via a first network;
a second communication section for receiving the encryption key information made into a stream from the server via a second network having a speed lower than the first network; and
a decryption section for decrypting the encrypted contents information received by the first communication section using the encryption key information received by the second communication section.

2. The contents distribution system according to claim 1, wherein the server further comprises a transmission measuring section for measuring the state of transmission of the encryption key information for enabling the user terminal to receive the encryption key information by the second communication section.

3. The contents distribution system according to claim 2, wherein the transmission measuring section measures transmission time and/or the number of transmissions of the encryption key information to the user terminal.

4. The contents distribution system according to claim 1, wherein the server further comprises a charging processing section for calculating use charge based on the encrypted contents information and/or the encryption key information, each information being received by the user terminal via the network.

5. The contents distribution system according to claim 2, wherein the server further comprises a charging processing section for calculating use charge based on the encrypted contents information and/or the encryption key information, each information being received by the user terminal via the network.

6. The contents distribution system according to claim 3, wherein the server further comprises a charging processing section for calculating use charge based on the encrypted contents information and/or the encryption key information, each information being received by the user terminal via the network.

7. The contents distribution system according to claim 1, wherein the user terminal further comprises a display for displaying the encrypted contents information decrypted by the decryption section.

8. The contents distribution system according to claim 2, wherein the user terminal further comprises a display for displaying the encrypted contents information decrypted by the decryption section.

9. The contents distribution system according to claim 3, wherein the user terminal further comprises a display for displaying the encrypted contents information decrypted by the decryption section.

10. The contents distribution system according to claim 4, wherein the user terminal further comprises a display for displaying the encrypted contents information decrypted by the decryption section.

11. The contents distribution system according to claim 1, wherein the server further comprises:
a generation section for generating partial contents information which is contents information acquired by the acquisition section and which is not encrypted by the encryption section, and
a partial contents information disclosing section for enabling the non-encrypted partial contents information generated by the generation section to be disclosed and viewed by the user terminal.

12. The contents distribution system according to claim 2, wherein the server further comprises:
a generation section for generating partial contents information which is contents information acquired by the acquisition section and which is not encrypted by the encryption section, and
a partial contents information disclosing section for enabling the non-encrypted partial contents information generated by the generation section to be disclosed and viewed by the user terminal.

13. The contents distribution system according to claim 3, wherein the server further comprises:
a generation section for generating partial contents information which is contents information acquired by the acquisition section and which is not encrypted by the encryption section, and
a partial contents information disclosing section for enabling the non-encrypted partial contents information generated by the generation section to be disclosed and viewed by the user terminal.

14. The contents distribution system according to claim 4, wherein the server further comprises:
a generation section for generating partial contents information which is contents information acquired by the acquisition section and which is not encrypted by the encryption section, and
a partial contents information disclosing section for enabling the non-encrypted partial contents information generated by the generation section to be disclosed and viewed by the user terminal.

15. The contents distribution system according to claim 7, wherein the server further comprises:
a generation section for generating partial contents information which is contents information acquired by the acquisition section and which is not encrypted by the encryption section, and
a partial contents information disclosing section for enabling the non-encrypted partial contents information generated by the generation section to be disclosed and viewed by the user terminal.

16. The contents distribution system according to claim 1, wherein the server further comprises an encryption key location information disclosing section for enabling information of location where the encryption key information is stored by the encryption key storage to be disclosed and viewed by the user terminal.

17. The contents distribution system according to claim 2, wherein the server further comprises an encryption key location information disclosing section for enabling information of location where the encryption key information is stored by the encryption key storage to be disclosed and viewed by the user terminal.

18. The contents distribution system according to claim 3, wherein the server further comprises an encryption key location information disclosing section for enabling information of location where the encryption key information is stored by the encryption key storage to be disclosed and viewed by the user terminal.

19. The contents distribution system according to claim 4, wherein the server further comprises an encryption key location information disclosing section for enabling information of location where the encryption key information is stored by the encryption key storage to be disclosed and viewed by the user terminal.

20. The contents distribution system according to claim 7, wherein the server further comprises an encryption key location information disclosing section for enabling information of location where the encryption key information is stored by the encryption key storage to be disclosed and viewed by the user terminal.

21. The contents distribution system according to claim 11, wherein the server further comprises an encryption key location information disclosing section for enabling information of location where the encryption key information is stored by the encryption key storage to be disclosed and viewed by the user terminal.

22. A server comprising:
an acquisition section for acquiring contents information;
an encryption section for encrypting contents information acquired by the acquisition section;
an encrypted contents storage for storing contents information encrypted by the encryption section;
an encryption key storage for making encryption key information used for encrypting by the encryption section into a stream, and storing the encryption key information; and
a communication section for transmitting the encrypted contents information via a first network, and transmitting the encryption key information made into a stream via a second network having a speed lower than the first network.

23. The server according to claim 22, further comprising a transmission measuring section for measuring the state of transmission of the encryption key information by the communication section.

24. The server according to claim 23, wherein the transmission measuring section measures transmission time and/or the number of transmissions of the encryption key information.

25. The server according to claim 22, further comprising a charging processing section for calculating use charge based on the encrypted contents information and/or encryption key information, each information being transmitted via the network.

26. The server according to claim 23, further comprising a charging processing section for calculating use charge based on the encrypted contents information and/or encryption key information, each information being transmitted via the network.

27. The server according to claim 24, further comprising a charging processing section for calculating use charge based on the encrypted contents information and/or encryption key information, each information being transmitted via the network.

28. A user terminal comprising:
a first communication section for receiving encrypted contents information via a first network;
a second communication section for receiving encryption key information made into a stream via a second network with a speed lower than the first network; and
a decryption section for decrypting the encrypted contents information received by the first communication section using the encryption key information received by the second communication section.

29. The user terminal according to claim 28, further comprising a display for displaying the encrypted contents information decrypted by the decryption section.

30. A contents encryption device comprising:
an acquisition section for acquiring contents information;
an encryption section for encrypting contents information acquired by the acquisition section; and
a streaming section for making encryption key information used for encrypting the contents information into a stream.

31. A contents managing device comprising:
an encrypted contents acquisition section for acquiring encrypted contents information;
an encrypted contents storage for storing the encrypted contents information acquired by the encrypted contents acquisition section; and
a communication section for transmitting the encrypted contents information via a network.

32. A streaming device comprising:
an encryption key information acquisition section for acquiring encryption key information which is made into a stream and used for encrypting contents information;
an encryption key storage for storing the encryption key information; and
a communication section for transmitting the encryption key information made into a stream via a network.

33. The streaming device according to claim 32, further comprising a transmission measuring section for measuring the state of transmission of the encryption key information by the communication section.

34. The streaming device according to claim 33, wherein the transmission measuring section measures transmission time and/or the number of transmissions of the encryption key information.

35. The streaming device according to claim 32, further comprising a charging processing section for calculating use charge based on the encrypted contents information and/or the encryption key information, each information being transmitted via the network.

36. The streaming device according to claim 33, further comprising a charging processing section for calculating use charge based on the encrypted contents information and/or the encryption key information, each information being transmitted via the network.

37. The streaming device according to claim 34, further comprising a charging processing section for calculating use charge based on the encrypted contents information and/or the encryption key information, each information being transmitted via the network.

38. A contents distribution method utilizing a server and a user terminal which are connected via a network, wherein:
the server comprises the steps of:
acquiring contents information by an acquisition section;
encrypting by an encryption section contents information acquired by the acquisition section;
storing by an encrypted contents storage the contents information encrypted by the encryption section;
making an encryption key storage convert encryption key information used for encrypting by the encryption section into a stream and store the encryption key information, and
the user terminal comprises the steps of:
receiving the encrypted contents information from the server by a first communication section via a first network;
receiving the encryption key information made into a stream from the server by a second communication section via a second network with a speed lower than the first network; and
decrypting by a decryption section the encrypted contents information received by the first communication section using the encryption key information received by the second communication section.

39. The contents distribution method according to claim 38, further comprising the step of measuring by a transmission measuring section the state of transmission of the encryption key information so as to enable the user terminal to receive the encryption key information by the second communication section.

40. The contents distribution method according to claim 39, wherein, in the measuring step, the transmission measuring section measures time and/or the number of times of transmission of the encryption key information to the user terminal.

41. The contents distribution method according to claim 38, wherein the server further comprises the step of calculating use charge by a charging processing section based on the encrypted contents information and/or the encryption key information, each information being received by the user terminal via the network.

42. The contents distribution method according to claim 39, wherein the server further comprises the step of calculating use charge by a charging processing section based on the encrypted contents information and/or the encryption key information, each information being received by the user terminal via the network.

43. The contents distribution method according to claim 40, wherein the server further comprises the step of calculating use charge by a charging processing section based on the encrypted contents information and/or the encryption key information, each information being received by the user terminal via the network.

44. The contents distribution method according to claim 38, wherein the user terminal further comprises the step of displaying by a display the encrypted contents information decrypted by the decryption section.

45. The contents distribution method according to claim 39, wherein the user terminal further comprises the step of displaying by a display the encrypted contents information decrypted by the decryption section.

46. The contents distribution method according to claim 40, wherein the user terminal further comprises the step of displaying by a display the encrypted contents information decrypted by the decryption section.

47. The contents distribution method according to claim 41, wherein the user terminal further comprises the step of displaying by a display the encrypted contents information decrypted by the decryption section.

48. The contents distribution method according to claim 38, wherein the server further comprises the steps of:
generating by a generation section partial contents information which is acquired by the acquisition section and which is not encrypted by the encryption section; and
enabling the non-encrypted partial contents information generated by the generation section to be disclosed by a partial contents information disclosing section and to be viewed by the user terminal.

49. The contents distribution method according to claim 39, wherein the server further comprises the steps of:
generating by a generation section partial contents information which is acquired by the acquisition section and which is not encrypted by the encryption section; and
enabling the non-encrypted partial contents information generated by the generation section to be disclosed by a partial contents information disclosing section and to be viewed by the user terminal.

50. The contents distribution method according to claim 40, wherein the server further comprises the steps of:
generating by a generation section partial contents information which is acquired by the acquisition section and which is not encrypted by the encryption section; and
enabling the non-encrypted partial contents information generated by the generation section to be disclosed by a partial contents information disclosing section and to be viewed by the user terminal.

51. The contents distribution method according to claim 41, wherein the server further comprises the steps of:
generating by a generation section partial contents information which is acquired by the acquisition section and which is not encrypted by the encryption section; and
enabling the non-encrypted partial contents information generated by the generation section to be disclosed by a partial contents information disclosing section and to be viewed by the user terminal.

52. The contents distribution method according to claim 44, wherein the server further comprises the steps of:
generating by a generation section partial contents information which is acquired by the acquisition section and which is not encrypted by the encryption section; and
enabling the non-encrypted partial contents information generated by the generation section to be disclosed by a partial contents information disclosing section and to be viewed by the user terminal.

53. The contents distribution method according to claim 38, wherein the server further comprises the step of disclosing by an encryption key location information disclosing section information of location where the encryption key information is stored by the encryption key storage to allow the user terminal to view the location information.

54. The contents distribution method according to claim 39, wherein the server further comprises the step of disclosing by an encryption key location information disclosing section information of location where the encryption key information is stored by the encryption key storage to allow the user terminal to view the location information.

55. The contents distribution method according to claim 40, wherein the server further comprises the step of disclosing by an encryption key location information disclosing section information of location where the encryption key information is stored by the encryption key storage to allow the user terminal to view the location information.

56. The contents distribution method according to claim 41, wherein the server further comprises the step of disclosing by an encryption key location information disclosing section information of location where the encryption key information is stored by the encryption key storage to allow the user terminal to view the location information.

57. The contents distribution method according to claim 44, wherein the server further comprises the step of disclosing by an encryption key location information disclosing section information of location where the encryption key information is stored by the encryption key storage to allow the user terminal to view the location information.

58. The contents distribution method according to claim 48, wherein the server further comprises the step of disclosing by an encryption key location information disclosing section information of location where the encryption key information is stored by the encryption key storage to allow the user terminal to view the location information.
